(19) United States
(12) Patent Application Publication
(10) Pub. No.: US 2015/0317394 A1
(43) Pub. Date: Nov. 5, 2015

(54) ELECTRONIC DEVICE AND METHOD FOR AUTOMATICALLY SEARCHING INFORMATION PERTAINING TO TARGET OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-JUN MAO, Shenzhen (CN); CHIH-SAN CHIANG, New Taipei (TW)

(21) Appl. No.: 14/685,857

(22) Filed: Apr. 14, 2015

(30) Foreign Application Priority Data
Apr. 30, 2014 (CN) 201410179678.0

(51) Int. Cl. G06F 17/30; G06F 3/041; G06F 3/0354; G06F 3/0488

(52) U.S. Cl. CPC G06F 17/30864; G06F 3/04883; G06F 3/041; G06F 3/03543; G06F 2203/04104; G06F 2203/04808

(57) ABSTRACT

A method for automatically searching information pertaining to a target object using an electronic device includes detecting a user operation applied to a document which is displayed, obtaining information regarding the detected user operation, and determining whether the information regarding the detected user operation matches information regarding a predetermined user operation. Upon determining a match, the target object which corresponds to the user operation is obtained, and a preset search tool is activated and controlled, without further input from a user, to search and retrieve information pertaining to the target object.

### CROSS-REFERENCE TO RELATED APPLICATIONS

This application claims priority to Chinese Patent Application No. 201410179678.0 filed on Apr. 30, 2014, the contents of which are incorporated by reference herein.

### FIELD

The subject matter herein generally relates to communications technology, and particularly to an electronic device and a method for automatically searching information pertaining to a target object.

### BACKGROUND

People usually want to learn more about some objects, such as words, character strings, sentences, or figures, when they read documents, in browsing web or reading articles. At this time, people may select and copy a target object in the document, manually activate a search tool, such as Internet search engine, e.g., Google, Baidu, or Sougou, or local search dictionary, e.g., Kingsoft or YoudaoDict, paste the copied target object into an input field of the search engine, and then press a search button to search more information pertaining to the copied target object.

### BRIEF DESCRIPTION OF THE DRAWINGS

Implementations of the present disclosure will now be described, by way of example only, with reference to the attached figures.

FIG. 1 is a block diagram of an example embodiment of an electronic device.

FIG. 2 is a flowchart of an example embodiment of a method for automatically searching information pertaining to a target object using the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts can be exaggerated to better illustrate details and features of the present disclosure.

Several definitions that apply throughout this disclosure will now be presented.

The term “comprising” means “including, but not necessarily limited to”; it specifically indicates open-ended inclusion or membership in a so-described combination, group, series and the like. The term “module” refers to logic embodied in hardware or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

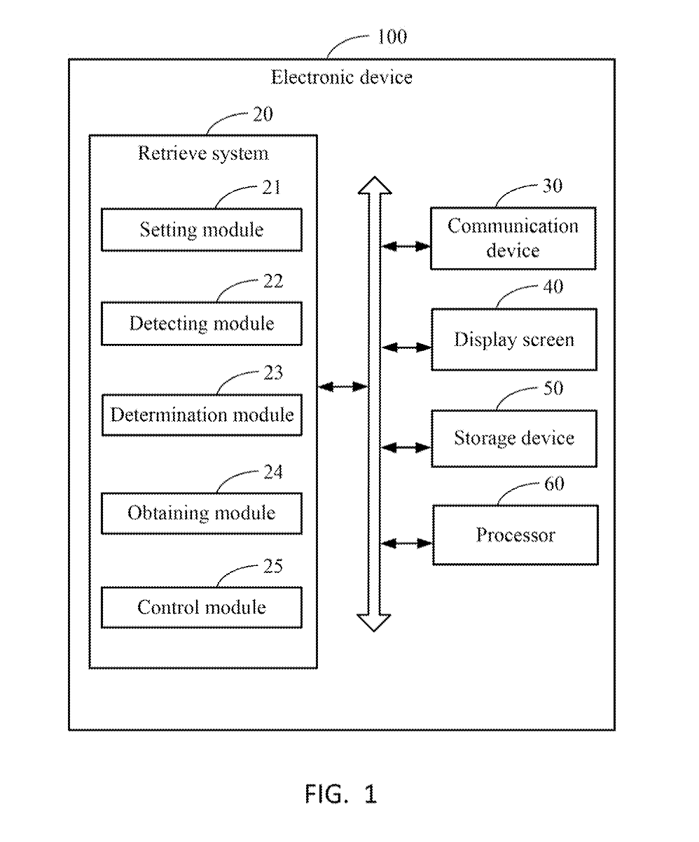

FIG. 1 is a block diagram of an example embodiment of an electronic device. In at least one embodiment, as shown in FIG. 1, an electronic device 100 includes, but is not limited to, a retrieve system 20, a communication device 30, a display screen 40, a storage device 50, and at least one processor 60. FIG. 1 illustrates only one example of the electronic device 100, other examples can comprise more or fewer components then as shown in the embodiment, or have a different configuration of the various components.

In one embodiment, the electronic device 100 can be mobile phone, personal digital assistant (PDA), tablet computer, or any other suitable electronic device. The communication device 30 can link the electronic device 100 to an Internet server (not shown).

The storage device 50 stores information regarding a predetermined user operation. The storage device 50 can be an internal storage device, such as a flash memory, a random access memory (RAM) for temporary storage of information, and/or a read-only memory (ROM) for permanent storage of information. The storage device 50 can also be an external storage device, such as an external hard disk, a storage card, or a data storage medium. The at least one processor 60 can be a central processing unit (CPU), a microprocessor, or other data processor chip that performs functions of the electronic device 100.

In one embodiment, the retrieve system 20 can determine a target object on a displayed document, in response to a user operation applied to the displayed document, and automatically activate and control, without further input from a user, a preset search tool to search and retrieve information pertaining to the target object. In at least one embodiment, the target object can be word, character string, sentence or sentences, or figure or figures.

In at least one embodiment, the retrieve system 20 can include a setting module 21, a detecting module 22, a determination module 23, an obtaining module 24, and a control module 25. Modules 21-25 can comprise computerized instructions in the form of one or more computer-readable programs that can be stored in a non-transitory computer-readable medium, for example in the storage device 50, and are executed by the at least one processor 60 of the electronic device 100 to provide functions of the present disclosure. A detailed description of the functions of the modules 21-25 is given below in reference to FIG. 1.

The setting module 21 presets a search tool and presets an address of an information source for the preset search tool, and stores the address in the storage device. In one embodiment, the preset search tool can be an Internet search engine, e.g., Google, Baidu, or Sougou, and the setting module 21 presets a web site as the address of an information source for the preset search tool. In other embodiments, the preset search tool can be a local search dictionary, e.g., Kingsoft or YoudaoDict, which can be installed in the electronic device 100, and the setting module 21 presets a path of the local search tool as the address of an information resource for the preset search tool.

The detecting module 22 detects a user operation applied to a document which is displayed on the display screen 40, and the obtaining module 24 obtains information regarding the detected user operation.

The determination module 23 determines whether the information regarding the detected user operation matches information regarding a predetermined user operation stored in the storage device 50.

In one embodiment, the type of the predetermined user operation can be selected from a group consisting of a multi-touch operation, a combination of a selection operation and touch gestures, and a combination of a selection operation and mouse click operation.

Upon determining that the information regarding the detected user operation matches the information regarding the predetermined user operation, the obtaining module 24 obtains a target object which corresponds to the user operation, and the control module 25 automatically activates and controls, without further input from a user, the preset search tool to search and retrieve information pertaining to the target object.

For example, if the predetermined user operation is selected to be a multi-touch operation, the obtaining module 24 obtains the content between two end touch points as the target object. If the predetermined user operation is selected to be a combination of a selection operation and touch gestures or mouse click operation, the obtaining module 24 obtains the target object according to the selection operation.

In at least one embodiment, the control module 25 automatically activates the preset search tool by obtaining the address of an information source for the preset search tool from the storage device 50.

In at least one embodiment, the control module 25 further controls the display screen 40 to display a search result interface provided by the preset search tool.

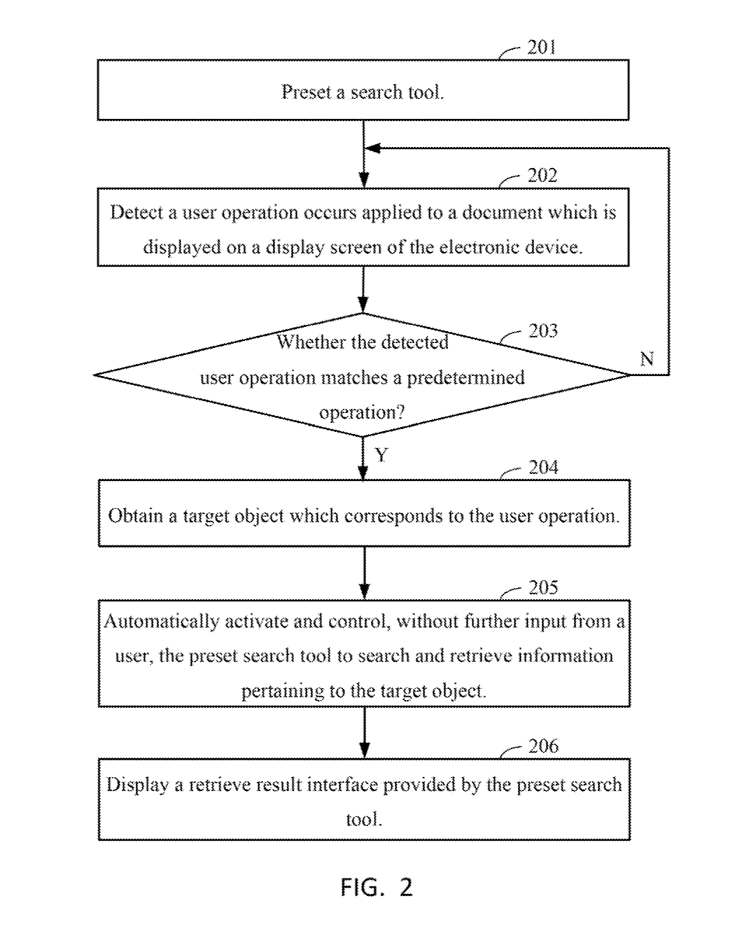

FIG. 2 illustrates a flowchart of an example embodiment of a method for automatically searching information pertaining to target object using an electronic device. In an example embodiment, the method 200 is performed by execution of computer-readable software program codes or instructions by at least one processor of the electronic device.

Referring to FIG. 2, a flowchart is presented in accordance with an example embodiment which is being thus illustrated. The example method 200 is provided by way of example, as there are a variety of ways to carry out the method. The method 200 described below can be carried out using the configurations illustrated in FIG. 1, for example, and various elements of these figures are referenced in explaining method 200. Each block shown in FIG. 2 represents one or more processes, methods, or subroutines carried out in the exemplary method 200. Furthermore, the illustrated order of blocks is by example only and the order of the blocks can change according to the present disclosure. Additional blocks can be added or fewer blocks can be utilized without departing from this disclosure. The example method 200 can begin at block 201.

At block 201, a setting module presets a search tool and presets an address of an information source for the preset search tool, and stores the address in a storage device of the electronic device.

At block 202, a detecting module detects a user operation applied to a document which is displayed on a display screen of the electronic device, and an obtaining module obtains information regarding the detected user operation.

At block 203, a determination module determines whether the information regarding the detected user operation matches information regarding a predetermined user operation stored in a storage device of the electronic device. If the information regarding the detected user operation matches the information regarding the predetermined user operation, block 204 is implemented. Otherwise, the process remains in block 202.

At block 204, the obtaining module 24 obtains a target object which corresponds to the user operation.

At block 205, a control module automatically activates and controls, without further input from a user, the preset search tool to search and retrieve information pertaining to the target object.

At block 206, the control module controls the display screen to display a search result interface provided by the preset search tool.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in particular the matters of shape, size, and arrangement of parts within the principles of the present disclosure, up to and including the full extent established by the broad general meaning of the terms used in the claims.

What is claimed is:

1. An electronic device for automatically searching information pertaining to a target object, the electronic device comprising:
a display screen;
at least one processor coupled to the display screen; and
a storage device storing one or more programs, which when executed by the at least one processor, cause the at least one processor to:
detect a user operation applied to a document which is displayed on the display screen, and obtain information regarding the detected user operation;
determine whether the information regarding the detected user operation matches information regarding a predetermined user operation stored in the storage device; and
upon determining that the information regarding the detected user operation matches the information regarding the predetermined user operation, obtain the target object which corresponds to the user operation, and activate and control, without further input from a user, a preset search tool to search and retrieve information pertaining to the target object.

2. The electronic device as described in claim 1, wherein the at least one processor further presets the preset search tool and presets an address of an information source for the preset search tool, and stores the address in the storage device, wherein the at least one processor further obtains the address of an information source for the preset search tool from the storage device and activates the preset search tool according to the address.

3. The electronic device as described in claim 2, wherein the preset search tool is an Internet search engine, and the at least one processor presets a web site as the address of an information source for the preset search tool.

4. The electronic device as described in claim 2, wherein the preset search tool is a local search tool installed in the electronic device, and the at least one processor presets a path of the local search tool as the address of an information resource for the preset search tool.

5. The electronic device as described in claim 1, wherein the type of the predetermined user operation is selected from a group consisting of a multi-touch operation, a combination of a selection operation and touch gestures, and a combination of a selection operation and mouse click operation.

6. The electronic device as described in claim 1, wherein the least one processor further controls the display screen to display a retrieve result interface provided by the preset search tool.

7. A computer-implemented method for automatically searching information pertaining to a target object using an electronic device, the method comprising:
detecting a user operation applied to a document which is displayed on a display screen of the electronic device, and obtain information regarding the detected user operation;
determining whether the information regarding the detected user operation matches information regarding a predetermined user operation stored in a storage device of the electronic device; and
upon determining that the information regarding the detected user operation matches the information regarding the predetermined user operation, obtaining the target object which corresponds to the user operation, and activating and controlling, without further input from a user, a preset search tool to search and retrieve information pertaining to the target object.

8. The method as described in claim 7, further comprising:
presetting the preset search tool and presetting an address of an information source for the preset search tool, and storing the address in the storage device of the electronic device.

9. The method as described in claim 8, wherein accessing a preset search tool comprises:
obtaining the address of an information source for the preset search tool from the storage device and activating the preset search tool according to the address.

10. The method as described in claim 9, wherein the preset search tool is an Internet search engine, and a web site is preset as the address of an information source for the preset search tool.

11. The method as described in claim 9, wherein the preset search tool is a local search tool installed in the electronic device, and a path of the local search tool is preset as the address of an information resource for the preset search tool.

12. The method as described in claim 7, wherein the type of the predetermined user operation is selected from a group consisting of a multi-touch operation, a combination of a selection operation and touch gestures, and a combination of a selection operation and mouse click operation.

13. The method as described in claim 7, further comprising:
controlling the display screen to display a retrieve result interface provided by the preset search tool.

14. A non-transitory storage medium having stored thereon instructions that, when executed by at least one processor of an electronic device, causing the electronic device to perform a method for automatically searching information pertaining to a target object, the method comprising:
detecting a user operation applied to a document which is displayed on a display screen of the electronic device, and obtain information regarding the detected user operation;
determining whether the information regarding the detected user operation matches information regarding a predetermined user operation stored in a storage device of the electronic device; and
upon determining that the information regarding the detected user operation matches the information regarding the predetermined user operation, obtaining the target object which corresponds to the user operation, and activating and controlling, without further input from a user, a preset search tool to search and retrieve information pertaining to the target object.

15. The non-transitory storage medium as described in claim 14, wherein the method further comprising:
presetting the preset search tool and presetting an address of an information source for the preset search tool, and storing the address in the storage device of the electronic device.

16. The non-transitory storage medium as described in claim 15, wherein activating a preset search tool comprises:
obtaining the address of an information source for the preset search tool from the storage device and activating the preset search tool according to the address.

17. The non-transitory storage medium as described in claim 16, wherein the preset search tool is an Internet search engine, and a web site is preset as the address of an information source for the preset search tool.

18. The non-transitory storage medium as described in claim 16, wherein the preset search tool is a local search tool installed in the electronic device, and a path of the local search tool is preset as the address of an information source the preset search tool.

19. The non-transitory storage medium as described in claim 14, wherein the type of the predetermined user operation is selected from a group consisting of a multi-touch operation, a combination of a selection operation and touch gestures, and a combination of a selection operation and mouse click operation.

20. The non-transitory storage medium as described in claim 14, wherein the method further comprising:
controlling the display screen to display a retrieve result interface provided by the preset search tool.
